(19) United States
(12) Patent Application Publication
(10) Pub. No.: US 2008/0221867 A1
(43) Pub. Date: Sep. 11, 2008

(54) SYSTEM AND METHOD FOR INTERNATIONALIZATION

(75) Inventor: Zvi Schreiber, Jerusalem (IL)

Correspondence Address: SIMON KAHN - PYI Tech, Ltd.;c/o LANDONIP, INC, 1700 DIAGONAL ROAD, SUITE 450, ALEXANDRIA, VA, 22314-2866, US

(73) Assignee: GHOST INC., Tortola (VG)

(21) Appl. No.: 12/045,038

(22) Filed: Mar. 10, 2008

Related U.S. Application Data
(60) Provisional application No. 60/893,968, filed on Mar. 9, 2007.

(51) Int. Cl. G06F 17/20

(52) U.S. Cl. 704/8

(57) ABSTRACT

A system and method for internationalizing user interfaces associated with Web pages and other software and especially interactive web pages. Translation files are stored in a server and transmitted to clients as needed. Preferably strings are arranged in a tree so that the client can request specific subtrees. The user interface responds dynamically to a change in the user's language preference, without requiring a restart of the application.

### CROSS-REFERENCE TO RELATED APPLICATIONS

This application claims priority from U.S. Provisional Patent Application Ser. No. 60,893,968 filed Mar. 9, 2007, entitled “Virtual Hosted Operating System” the entire contents of which is incorporated herein by reference.

### BACKGROUND OF THE INVENTION

This application is in related to displaying screen information for computer software, and in particular to a computer implemented method of displaying screen information in accordance with a user's preferred language.

Many modern software systems have user interfaces, often graphical user interfaces, which include many strings such as labels for menus and buttons, information for the user and instructions for the user. It is often desirable to make these available in multiple languages.

These software systems include software which is installed on a computer, such as software packages for installation on Microsoft Windows; static Web sites generated or served by a Web server and downloaded as html pages by a Web browser; interactive Web pages such as HTML pages with embedded Flash, Java applet; or Javascript and DHTML, known as AJAX programs, which are downloaded to a Web browser on a client computer and then executed on the client computer.

The user interfaces are often divided into groupings of strings and other elements which are often displayed together and which can be generally called “screens”. These may include specific dialog boxes in a graphical user interface or a Web page.

Many user interfaces on installed software and web sites today support multiple languages, i.e. internationalization. Current solutions for internationalization often have one or more of the following disadvantages:
All translations are transmitted to the client, rather than just the original language and the user's choice of language, increasing the download or install time;
Changing the user's language preference requires restarting or even reinstalling the software or reloading the Web page;
In many embodiments, all strings with their translations, are sent to each screen and not just the subset of strings needed by the screen, using extra bandwidth and possibly delaying the initialization of the string;
In the event that the same strings are used in different screens, they are configured twice and have to be translated twice increasing costs and increasing the risk of inconsistent translations;
The software cannot function with partial translations, i.e. there is no default values for missing translations and no indication of missing translations;
The software vendor is often not able to provide new languages or to update existing translations without creating a new release of the entire software; and
Translators are sometimes presented a string to translate without seeing the context of where that string is used in a screen.

There are many graphical user interface internationalization libraries known in the art, such as GTK+, available from www.gtk.org. Many of them contain each language in a properties file which has a long flat list of name-value pairs of the format:

string-identifier=translation-of-string.

Typically the entire properties file must be bundled with the software or transmitted to the software which can be inefficient. Often all translation files are bundled with the software even though a given user only requires a single language. In the event of user's request to change language, many prior art embodiments require a restart or even a reinstall of the software. Furthermore, introducing new languages or changes to translations usually requires a new version of the software.

Collaborative editing of dictionaries and texts in multiple languages is known to the prior art, as exemplified by www.wiktionary.org and www.wikipedia.org from MediaWiki Inc. However, collaborative editing has not been applied to translating software user interfaces which require special consideration.

Thus, what is required is a means for internationalization exhibit at least some improvement over the prior art, by overcoming at least one of the disadvantages mentioned above.

### SUMMARY OF THE INVENTION

Accordingly, it is a principal object of the present invention to provide a computer implemented method of internationalization. In one embodiment, internationalization is provided by storing sets of strings, in a plurality of languages, on a server. A client, embodied in one or more of client software, a static web page or a dynamic web page, requests strings in a desired language from the server. Preferably, the desired language is provided by one of the selected preferred language of a web browser, a user selection and a language associated with the IP address of the client.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of an overall architecture of a system in accordance with a principle of the invention;

FIG. 2 illustrates an internationalized string implemented in XML in accordance with a principle of the invention;

FIG. 3 illustrates an XML tree of user interface strings, in accordance with a principle of the invention;

FIG. 4 illustrates a translator graphical user interface, in accordance with a principle of the invention;

FIG. 5 illustrates an embodiment of a database table, or simple DB domain design for internationalized strings;

FIG. 6 illustrates a sample interactive web site user interface, wherein displayed strings are immediately responsive to the language choice presented; and

FIG. 7 illustrates a high level flow chart of a method according to a principle of the invention to supply a client with strings in the appropriate language.

### DETAILED DESCRIPTION OF THE PREFERRED EMBODIMENTS

The present embodiments enable a computer implemented method of internationalization by storing sets of strings, in a plurality of languages, on a server. A client, embodied in one or more of client software, a static web page or a dynamic web page, requests strings in a desired language from the server. Preferably, the desired language is provided by one of the selected preferred language of a web browser, a user selection and a language associated with the IP address of the client.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

### Overall Architecture

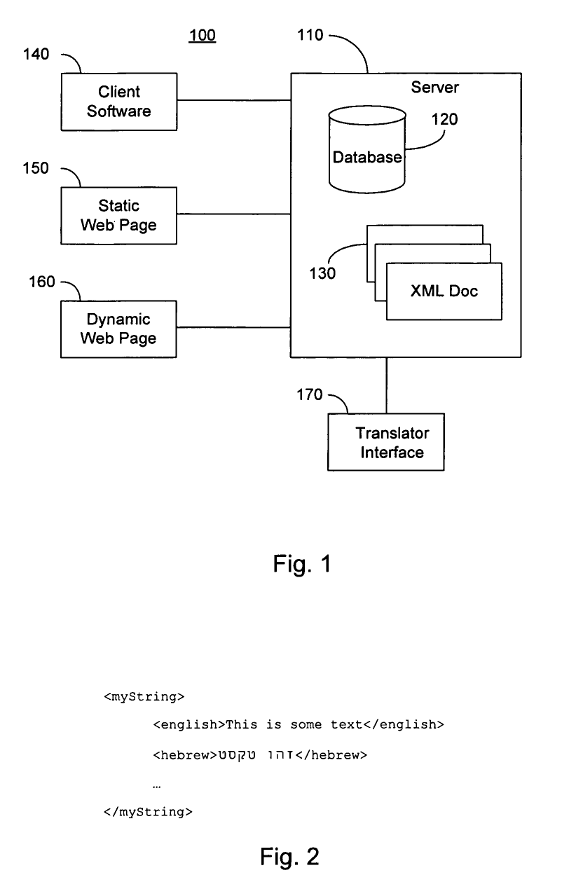

FIG. 1 illustrates a high level block diagram of an overall architecture 100, in accordance with an embodiment of the invention, comprising: a server 110 comprising at least one of a database 120 and a plurality of XML documents 130; an optional client software module 140; an optional static web page 150; an optional dynamic web page 160; and a translator interface 170. Server 110 is in communication with each of client software module 140, static web page 150, dynamic web page 162 and translator interface 170.

In one embodiment, translations of all strings for the user interfaces of any of client software module 140, static web page 150 and dynamic web page 160 are stored in server 110 either using database 120 or using a plurality of XML documents 130, preferably at least one XML document 130 for each language. The advantage of an XML document is that it has a natural tree structure allowing a client to request not only a specific string by identifiers or the entire set of strings, but also a specific subtree.

There is no requirement that each of client software module 140, web page 150 and dynamic web page 160 be present. In one embodiment, the present one of client software module 140, static web page 150 and dynamic web page 160 is in communication with server 110 via one of a local area network, a wide area network and the Internet. Translator interface 170 is in communication with server 110 via one of a local area network, a wide area network and the Internet.

According to an embodiment of the invention, one or more of client software module 140, static web page 150 and dynamic web page 160 are operative to retrieve translations of strings from server 110 and display them to the user in one or more screens of a user interface. It is to be understood that a plurality of client software modules 140, static web pages 150 and/or dynamic web pages 160 may be present in architecture 100 without exceeding the scope of the invention. Each of client software modules 140, static web page 150 and dynamic web page 160 are displayed to user on a computer monitor, and generated in a computing platform attached to the computer monitor.

Static web page 150 is preferably a static HTML web page, which however is static on the client but in one embodiment is generated dynamically by a Web server running on server 1 10. In one further embodiment the static HTML is generated by one or more Java Server Pages or Active Server Pages. Dynamic web page 160 is in one embodiment downloaded and then executed on the client. In one further embodiment, dynamic web page 160 is executing using Flash, a Java Applet or a combination of Javascript and DHTML known as AJAX.

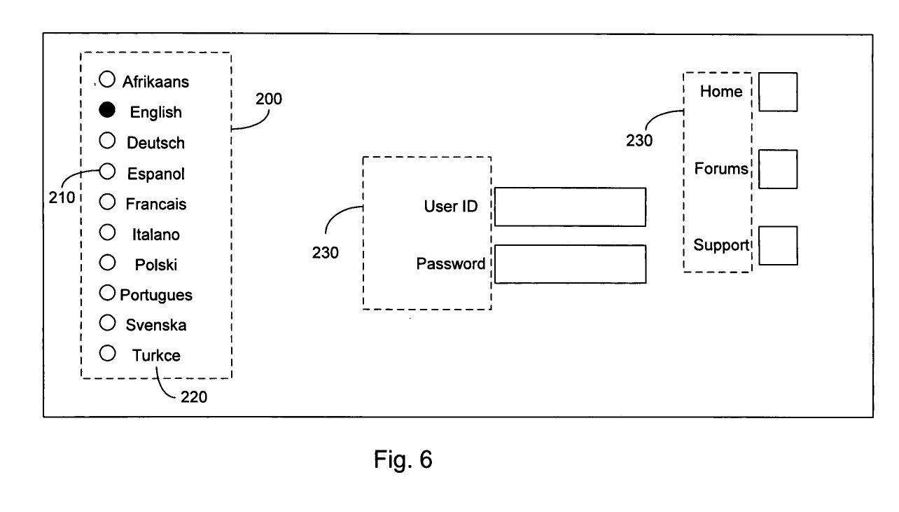

FIG. 6 illustrates an example of a screen of a user interface of a dynamic web page 160 exhibiting internationalized strings and a language selector. In particular, in area 200, a plurality of buttons 210 are supplied, each representing a particular language. Adjacent each button 210 is a language descriptor 220 in the native language, denoting the language of the adjacent button. Thus, for each button 210 selected a particular language is designated for the interface consonant with language descriptor 220 of the selected button 210. A plurality of strings 230 are further displayed on dynamic web page 160. In accordance with a principle of the invention, each of the strings 230 are displayed in the language consonant with language descriptor 220 of the selected button 210.

In one embodiment, each of client software 140, static web page 150 or dynamic web page 160 sends an HTTP request to server 110 to retrieve the specific language and the specific string, or all strings, or a subtree of strings of interest, either for the entire client or for each screen separately. Each of client software 140, static web page 150 or dynamic web page 160 then displays each of those strings in the user's preferred language.

In each case, a user preference determines in which language strings are displayed. The user preference may be obtained from a browser language choice, particularly since most modern browsers allow the user to choose a preferred language or languages. In one embodiment, the preferred language is transmitted to the server as an HTTP header called Accept-Language, known to those skilled in the art. In another embodiment, the language of choice is selected by the user explicitly as described above in relation to Error! Reference source not found.

The user language preference may be preserved from session to session in a database of server 110, preferably referenced by the User ID used for login, in a browser cookie, or in a client file. The use of a browser cookie is particularly preferable for use with services which are accessed anonymously. Until the user selects a language, in one embodiment a default language is used. In another embodiment, the user's IP address may be examined to determine the country associated with the IP address, and a language associated with the determined country is used.

Translator interface 170 is provided for use by actual translators. Translator interface 170 is operative to allow a translator to read strings stored on one or more of database 120 and XML documents 130 in the origin language and write translations to a similarly structured document. In one embodiment, in which XML documents are provided, the translations are stored on similarly formatted XML documents 130.

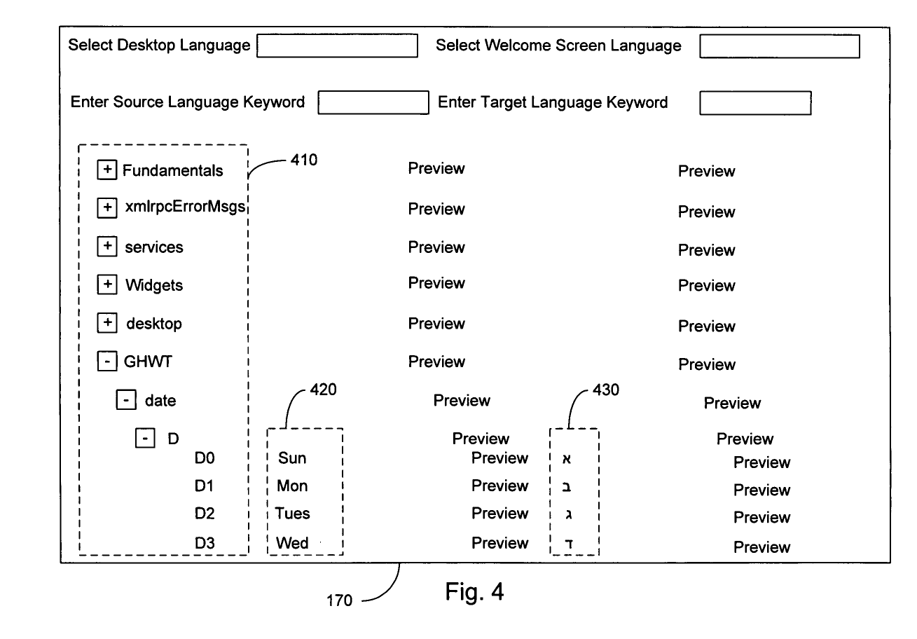

FIG. 4 shows an example of translator interface 170 where the main section shows, from left to right: a tree of unique identifiers for the strings 410, with the expanded part of the tree showing a section GhWT, comprising a section date, in which a section labeled D for the days of the week; the original language strings 420, shown as English; and a space 430 to place translations, shown as translations to Hebrew. Translator interface 170 further exhibits search facilities for keywords, links to select the translated language for immediate viewing in translator interface 170, and links to preview each of the strings and translations. Preferably, a pre-defined color labels any branch in the tree of a string which has missing or an outdate translations.

Thus, utilizing translator interface 170 enables translators presented with a string to translate to see the context of where that string is used in a screen, by pressing on the appropriate preview link.

### The ITest Class

In one embodiment a single object oriented class in a Client-side object oriented programming language such as Flash, JavaScript or OpenLaszlo, available from Laszlo Inc. of San Mateo, Calif., denoted hereinafter as IText, is responsible for displaying each single internationalized text as part of a screen in an interactive Web site.

In one further embodiment each internationalized GUI string has a unique identifier which preferably has a hierarchical structure such as:

strings/module2/component1/alert1/alerttitle; (Example 1) or
strings/desktopStrings/logout/logoutWarningTitle

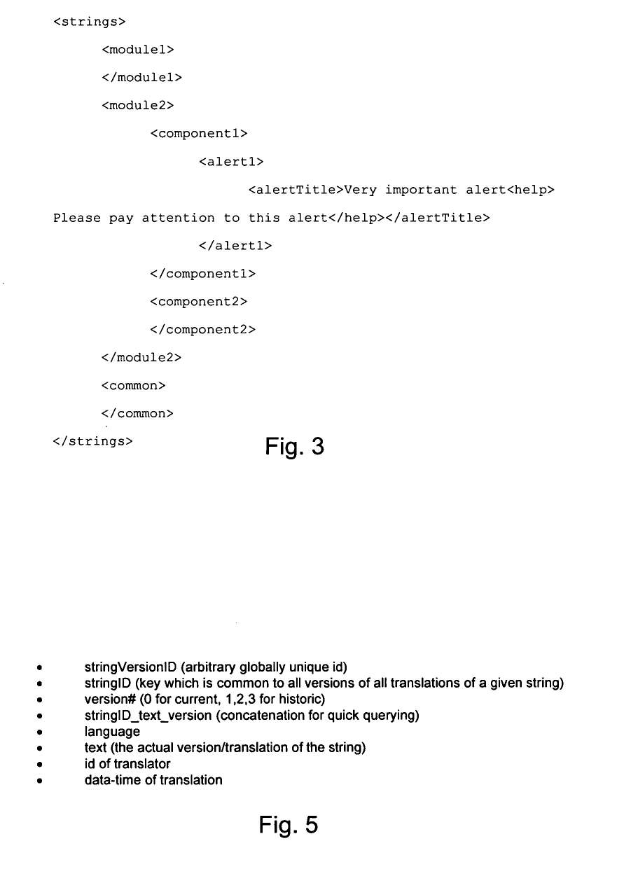

and each IText contains a reference to the unique identifier of the internationalized string it is to display. FIG. 3 illustrates an XML tree of user interface strings, consonant with Example 1 above.

The full source code for a possible realization of IText in the OpenLaszlo language, denoted GhWTText, and covered by copyright, is:

```
<library>
    <!---
        GhWTText displays simple or internationalized text according
to the language and the other seetings (font, color) etc. in the
given GhWTEnvironment.
      Three types of text are supported:
      * An internationalized XML LzDataElement which has all the
languages like
<anelement><english>text</english><french>...</anelement>...
        - in this case the data is an LzDataElement
      * A dataset and datapath to a string in the current language
- in that case the dataset is responsible for changing its data when
the language changes
            - in this case the data is a string with
datapath???
        (and a backup dataset with english should be provided for
when the language is missing)
      * A fixed non-internationalized text
        - in this case the data is a string
      There are three ways to provide the data (whether an
LzDataElement or a string):
      * gtext gives the data explicitly
      * gtext gives a datapath to finding the data in a dataset
(Code is gtext = ‘@#’ followed by the path) - by default the
stringsDS in the environment
      * The .data of the GhWTText contains the data (set using the
normal datapath - useful for data replication of GhWTText. Code is
gtext = ‘#@’)
        Font, font size, font color will be given by the
environment (which by default is the parent's environment variable as
usual)
        These may be overridden using gfont, gfontsize and
gfgcolor respectively.
        A mouseover may be given explicitly and in the case of a
datapath or LzDataElement if there is a child element help that will
be used by default.
        Will be clickable if there is a mouseover color or
mouseover text.
    -->
    <class name=“GhWTText” extends=“text”
            clickable=“${(this[‘mouseovergtext’]==null ? false
: (true || this.mouseovergtext))
                            ||
(this[‘mouseovergfgcolor’]==null ? false : (true ||
this.mouseovergfgcolor))}” resize=“false”>
        <!--- Pointer to the GhWTEnvironment. Default: Look for
parent's environment variable. - the object pointed to must have a
language variable and datasets with an XML tree of strings in English
as default and in the current language -->
        <attribute name=“environment” type=“expression”
value=“$once{parent.environment}”/>
        <!--- An internationalized text element. May be any one
of:
        * An LzDataElement with multi-language name children like
<anelement><english>text</english><french>...</anelement>...
        * ‘#@’ if the fixed text or internationalized
LzDataElement are to be given by the .data attribute set by the
normal datapath
        * ‘@#’ followed by a datapath into the stringsDS provided
(by default environment.StringsDS) @# e.g.
gtext=“‘@#/strings/aninternationalelement’”
          - if the path is to a a multi-language LzDataElement
(rather than a simple text) then include a ‘/’ at the end
        * Fixed non-internationalized text e.g. gtext=“‘Sorry
English only’”
        -->
        <attribute name=“gtext”/>
        <!--- Color of font - default: link this to the
Environment -->
        <attribute name=“gfgcolor” type=“color”
value=“${this.environment.gfgcolor}”/>
        <!--- Font - default: link this to the Environment -->
        <attribute name=“gfont” type=“text”
value=“${this.environment.gfont}”/>
        <!--- Font size - default: link this to the Environment -
->
        <attribute name=“gfontsize” type=“number”
value=“${this.environment.gfontsize}”/>
        <!--- Color of font during mouseover (conventionally blue
for hyperlinks) use with clickable=“true” -->
        <attribute name=“mouseovergfgcolor” type=“color”/>
        <!--- Is the string is found in the current language.
Otherwise color will be red. -->
        <attribute name=“langFound” type=“boolean” value=“true”/>
        <!--- If gtext is equal to this 2 character code then the
gtext will be taken from .data instead - default #@ -->
        <attribute name=“useDataCode” type=“string” value=“#@”/>
        <!--- If gtext starts with this 2 character code then the
rest of gtext is a datapath into the stringsDSs - default @# -->
        <attribute name=“isADatapathCode” type=“string”
value=“@#”/>
        <!--- The dataset to read strings from if given by a
datapath - default is environment.stringsDS -->
        <attribute name=“stringsDS1”
value=“${this.environment.stringsDS}”/>
        <!--- The backup dataset to read strings from if not
available in the primary (usually used for English) - default is
canvas.stringsEnglishDS -->
        <attribute name=“stringsDS2”
value=“${canvas.stringsEnglishDS}”/>
        <!--====================-->
        <!-- Private attributes -->
        <!--====================-->
        <!-- Will be equal to gtext if not ‘#@’ or equal to the
.data if gtext=‘#@’ (set ondata below) -->
        <attribute name=“_gtext” value=“${this[‘gtext’]==null ?
null : this.gtext}”/>
        <!-- The datapath from _gtext if any -->
        <attribute name=“_gtextDatapath”/>
        <!-- Will be equal to gtext if it is a string or
LzDataElement - but if gtext is a datapath this will equal to the
actual value -->
        <attribute name=“_gtextValue”
value=“${this[‘_gtext’]==null ? null : this._gtext}”/>
        <!--======================-->
        <!-- Mouseover attributes -->
        <!--======================-->
        <!--- An internationalized text element for mouseover.
Optional. If gtext is a datapath or dataelement this will
        default to the subelement <help> if any. May also be
given explicitly as any one of:
        An LzDataElement with multi-language name children like
<anelement><english>text</english><french>...</anelement>...
        A datapath preceded by a @# e.g.
gtext=“‘@#dataset:/adatapath/aninternationalelement’”
        Fixed non-internationalized text e.g. gtext=“‘Sorry
English only’”
        -->
        <attribute name=“mouseovergtext” value=“${(true ||
this.gtext)? this.getMouseovergtext( ) : notused}”/>
        <!--- Work out the gtext for the mouseover by going to
the help/ child of the _gtext -->
        <method name=“getMouseovergtext”> <![CDATA[
            if (this[‘_gtext’]==null) {return (null);}
            if (_gtext instanceof LzDataElement) { //
LzDataElement - look for help child
                return
(this._gtext.getElementsByTagName(‘help’)[0]);
            } else {
                if (this._gtext.slice(0,2) ==
this.isADatapathCode) { // datapath - add help to the end
                    return (this._gtext +
((this._gtext.slice(this._gtext.length−1)==‘/’) ? ‘help/’ : ‘/help’)
);
                } else { // fixed text
                    return (null);
                }
            }
        ]]> </method>
    <!--- Multiline text. Default: false. If multiline is false
then resize will be set to true. -->
    <attribute name=“mouseovermultiline” type=“boolean”
value=“false”/>
    <!--- Width of mouseover. Default: 200. Use with multiline only
(single line will resize) -->
    <attribute name=“mouseoverwidth” type=“number” value=“200”/>
        <!--======================-->
        <!-- Methods -->
        <!--======================-->
        <method name=“init”>
                super.init( );
                this.setAttribute(‘fontsize’,
this.gfontsize);
                this.setAttribute(‘font’, this.gfont);
                this._updateFgcolor( );
                if (!this.multiline)
{this.setHeight(this.gfontsize+8);}
                this.set_gtextDatapath( );
        </method>
        <handler name=“onlangFound”> this._updateFgcolor( );
</handler>
        <handler name=“on_gtext”> this.set_gtextDatapath( );
</handler>
        <method name=“set_gtextDatapath”> <![CDATA[
            if (this[‘_gtext’] && this._gtext.slice(0,2) ==
this.isADatapathCode) {
                this.setAttribute(‘_gtextDatapath’,
                        this._gtext.slice(2) +
((this._gtext.slice(this._gtext.length−1)==‘/’) ? ‘’ : ‘/text( )’ ) );
            }
        ]]> </method>
        <state apply=“${parent.clickable}”>
            <handler name=“onmouseover”>
                if (this[‘mouseovergfgcolor’]!=null)
{this.setAttribute(‘fgcolor’, mouseovergfgcolor);}
            </handler>
            <handler name=“onmouseout”> this._updateFgcolor( );
</handler>
        </state>
        <handler name=“ongfgcolor”> this._updateFgcolor( );
</handler>
        <handler name=“ongfontsize”>
            this.setAttribute(‘fontsize’, this.gfontsize);
            if (!this.multiline)
{this.setHeight(this.gfontsize+8);}
        </handler>
        <handler name=“ongfont”>
            this.setAttribute(‘font’, this.gfont);
        </handler>
        <!--- mySetText is same as setText but may be overridden
e.g. to add post-processing -->
        <method name=“mySetText” args=“s”>this.setText(s)
</method>
        <method name=“_updateFgcolor”>
            this.setAttribute(‘fgcolor’,
((this.langFound)?this.gfgcolor:red));
            this.fgcolor = (this.langFound)?this.gfgcolor:red;
        </method>
        <handler name=“ondata”>
            if (this[‘data’]!=null &amp;&amp; this[‘gtext’] ==
this.useDataCode) {
                this.setAttribute(‘_gtext’,this.data);
            }
            // the superclass text might try to setText based
on the data even when we don't want it so we need to override that
            if (this._gtextValue instanceof LzDataElement)
{LzTimer.addTimer(this._updateLangDlgt, 200);}
        </handler>
        <!--===========================-->
        <!-- Datapath case -->
        <!--===========================-->
        <state apply=“${classroot[‘_gtextDatapath’]==null ? false
: classroot._gtextDatapath}” onapply=“parent._getValue( );”>
            <handler name=“ondata” reference=“this.stringsDS1”>
<![CDATA[
                if (this.stringsDS1.data) {this._getValue( );}
            ]]> </handler>
            <handler name=“ondata” reference=“this.stringsDS2”>
<![CDATA[
                if (this.stringsDS2.data) {this._getValue( );}
            ]]> </handler>
            <handler name=“onerror”
reference=“this.stringsDS1”> <![CDATA[
                this.setAttribute(‘langFound’, false)
                this.setAttribute(‘_gtextValue’,
this.stringsDS2.getPointer( ).xpathQuery(this._gtextDatapath));
            ]]> </handler>
            <handler name=“on_gtextDatapath”> <![CDATA[
                this._getValue( );
            ]]> </handler>
            <method name=“_getValue”> <![CDATA[
                if(this.environment.language == ‘english’)
                {
                    this.setAttribute(‘_gtextValue’,
this.stringsDS2.getPointer( ).xpathQuery(this._gtextDatapath));
                    this.setAttribute(‘langFound’, true);
                }
                else
                {
                    this.setAttribute(‘_gtextValue’,
this.stringsDS1.getPointer( ).xpathQuery(this._gtextDatapath));
                    if (this._gtextValue) {
                        this.setAttribute(‘langFound’,
true)
                    } else { // go to backup dataset (e.g.
English)
                        this.setAttribute(‘langFound’,
false)
                        this.setAttribute(‘_gtextValue’,
this.stringsDS2.getPointer( ).xpathQuery(this._gtextDatapath));
                    }
                }
            ]]> </method>
        </state>
        <!--===========================-->
        <!-- LzDataElement case -->
        <!--===========================-->
        <state apply=“${classroot._gtextValue instanceof
LzDataElement}” onapply=“parent._updateLanguage( );”>
            <attribute name=“_updateLangDlgt” value=“$once{new
LzDelegate(this, ‘_updateLanguage’)}”/>
            <!--
            <handler name=“onlanguage”
reference=“this.environment”>
                this._updateLanguage( );
            </handler>
              -->
            <!-- This fires if the language just changed -->
            <handler name=“onLanguageChanged”
reference=“this.environment”>
                this._updateLanguage( );
            </handler>
            <handler name=“on_gtextValue”>
                this._updateLanguage( );
            </handler>
            <!--- Update the text after a change in the
language or a change in the internationalized text -->
            <method name=“_updateLanguage”> <![CDATA[
                var lang = this[‘environment’]!=null ?
this.environment.language : ‘english’
                if
(this._gtextValue.getElementsByTagName(lang).length == 0) { //i.e.
if language not found
                    this.setAttribute(‘langFound’, false);
    this.mySetText(this._gtextValue.getElementsByTagName(‘english’)
[0].getFirstChild( ).data); // default to English
                } else {
                    this.setAttribute(‘langFound’, true);
    this.mysetText(this._gtextValue.getElementsByTagName(lang)[0].-
getFirstChild( ).data);
                }
            ]]> </method>
        </state>
        <!--===============================-->
        <!-- Non-LzDataElement (text) case -->
        <!--===============================-->
        <state apply=“${!(classroot._gtextValue instanceof
LzDataElement)}”
onapply=“classroot.mySetText(classroot._gtextValue);”>
            <!-- <node
oninit=“classroot.mySetText(classroot._gtextValue);this.destroy( );”/>
Workaround to OL4 bug - ZS - delete one day -->
            <handler name=“on_gtextValue”>
this.mySetText(this._gtextValue); </handler>
        </state>
        <!--=================-->
        <!-- Mouseover state -->
        <!--=================-->
        <state apply=“${classroot[‘mouseovergtext’]==null ? false
: (true || classroot.mouseovergtext)}”>
            <attribute name=“onmousehoverDlgt” value=“$once{new
LzDelegate(this,‘onmousehover’)}”/>
            <method event=“onmouseover”>
                LzTimer.addTimer(this.onmousehoverDlgt,500);
            </method>
            <method event=“onmouseout”>
                LzTimer.removeTimer(this.onmousehoverDlgt);
            </method>
            <method name=“onmousehover”> <![CDATA[
                var p = stringsEnglishDS.getPointer( );
                var
isHelp=p.xpathQuery(this._gtext.slice(3,this._gtext.length)+‘/help’+‘
/text( )’);
                var helpFound=true;
                if(isHelp==null){
                helpFound=false;
                }
                var m = new GhWTText (MouseoverView,
```

| | |
|---|---|
| {environment | :this.environment, |
| multiline | :true, |
| gtext | |
| :this.mouseovergtext, | |
| resize | :false, |
| width | :200, |
| gmouseovertext | :null, |
| clickable | :false, |
| name | :‘mouseovercontents’ |

```
} );
                if (m.text && helpFound)
{MouseoverView.setVisible(true);} else {m.destroy( );}
            ]]> </method>
        </state>
</class>
```

In this case the GhWTText object has a pointer called environment to another object, known as GhWTEnvironment, which contains the user's language preference as well as datasets with an XML tree of strings in both the origin language and in the user's preferred language.

In this embodiment the same GhWTText code may be used to display a fixed non-internationalized text, by setting gtext equal to a text; an internationalized text from an XML tree, by setting attribute gtext equal to ‘@#’ followed by an Xpath of the string in the dataset in the GhWTEnvironment; or may be provided a single string in multiple languages in a format like Error! Reference source not found.

### Transmitting All Languages for Single Strings

In one preferred embodiment, each IText object stores all the translations of an Internationalized Text which is retrieved from server 110 by a string identifier. Error! Reference source not found illustrates an example of an embodiment in which multiple translations of a single string are transmitted to IText and stored by IText—in this example an English text and a corresponding Hebrew text are captured in an XML element.

IText will then check the user's language preference in a global variable associated with client software 140, static web page 150 or dynamic web page 160 and IText will display the appropriate translation string. Preferably each IText will register to receive an event which is triggered when the user changes their language preference so that IText updates which translation it shows. In this embodiment all user interface strings are preferably transmitted from server 110 to client software 140, static web page 150 or dynamic web page 160 in a single XML file which has an XML element tree reflecting the identifier's hierarchy. Each leaf of the XML element tree preferably is constituted of an XML element with children reflecting all the translations in a format such as that in FIG. 17???. The XML file is stored in any of client software 140, static web page 150 or dynamic web page 160 in a place where it may be queried by every IText in accordance with the identifier. In one embodiment, the XML file is stored in an OpenLaszlo dataset and the identifier comprises an xpath into that dataset.

### Transmitting a Single Language for a Single String

In an alternative embodiment each IText will query server 110 for just the string and language required. In one embodiment server 110 exhibits a suitable API such as a REST API, known to those skilled in the art which. In one embodiment a query from IText will be of the form:

GET http://somerserver.com/translationStrings/{id-of-string}/{choice-of-language}
In this way only translations actually required by an active IText are retrieved; however there is an overhead of many separate HTTP requests.

### Strings in a Database

In the above embodiments, strings are requested one at a time by each IText, so it is possible to store the strings and their translations in a relational database table or in an Amazon Web Services SimpleDB domain on database 120 for server 110 to query as required. Error! Reference source not found shows the column/attribute names suitable for storing multiple translations of multiple strings.

In alternative preferred embodiments, the strings in the origin language and in each translation language are stored in an XML document as described above in relation to FIG. 3.

### Transmitting All Strings for a Single Language

In an alternative embodiment, client software 140, static web page 150 or dynamic web page 160 retrieve string files centrally for all ITexts. Each of client software 140, static web page 150 and/or dynamic web page 160 query to receive from server 110 just the translation which is relevant to the current user language choice. Preferably, client software 140, static web page 150 or dynamic web page 160 request from server 110 a single XML file, as described above in relation to FIG. 3 which has all the strings only in the language of choice, thus reducing the amount of data that needs to be transmitted and stored. The XML file preferably is constituted of an XML element tree reflecting the identifier's hierarchy, with each leaf exhibiting a single text reflecting the language of choice only.

Preferably XML attributes capture metadata about origin strings and translations. For example:

<string-identifier last-modified-date=”2008-02-25” last-modified-
by=”Fred”>translation here</string-identifier>

### Transmitting Some Strings in a Single Language

In another embodiment server 110 stores one or more XML documents 130 for each language in a format as described above in relation to FIG. 3. This allows each client software 140, static web page 150 or dynamic web page 160, or even each screen, to retrieve just a relevant subtree such as the subtree given by XPath strings/module2/component1. Xpath is a language for describing elements and subtrees in an XML document, known to those skilled in the art. This gives the efficiency of retrieving all relevant strings in one request without retrieving irrelevant strings. Further, some subtrees like strings/common may contain strings common to many screens or even to different clients which then only need to be translated once.

Each string may have metadata which is displayed by IText to the user upon a mouseover or right-click event such as the help text shown in strings/module2/component1/alert1/alertTitle/help of FIG. 3.

### Other Design Considerations

In one embodiment, whenever a translation is missing, IText selects a default language, which may be a general default language, or a default fall back language selected by a user. Preferably IText indicates that a default language is being used instead of the preferred user language, e.g. by showing the text in red so that a translator may be alerted that a translation is missing. Preferably whenever this occurs the user may submit a translation into their preferred language, either directly into the Internationalized String database or into a queue for review and moderation. Preferably, this is accomplished by a mouse click or right-clicking on the text shown, which IText may process.

In one embodiment, all users are allowed to be translators and/or the privilege to access the translator interface. In yet another embodiment, access to the translator interface is limited to certain users, and optionally for each such user to certain languages.

In one embodiment the same interface that is used by translators to translate strings is also used by developers to introduce new strings to the GUI with new identifiers.

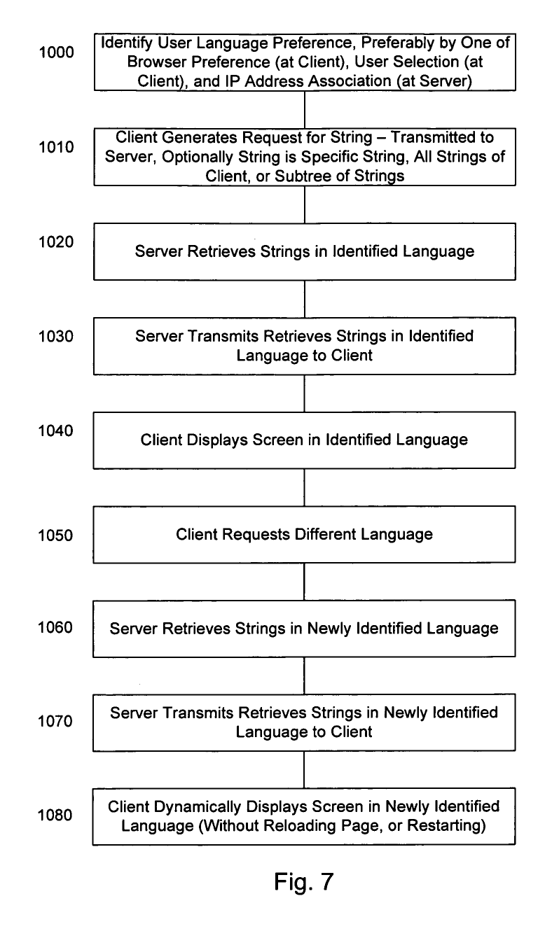

FIG. 7 illustrates a high level flow chart of an embodiment of a method, according to a principle of the invention, to supply a client with strings in the appropriate language. In stage 1000, the user's language preference is identified at the client, wherein the client is one of client software 140, static web page 150 and dynamic web page 160. In one embodiment, the user's language preference is identified responsive to the selected preferred language of the user's web browser. In another embodiment, the user's language preference is identified responsive to user input selection. In yet another embodiment, the user's language preference is identified at the server side by server 110, responsive to the IP address of the client.

In stage 1010, the client generates a request for a string, and transmits the request to server 100. In one embodiment the requested string is an identifier of a specific spring, preferably associated with a current screen. In another embodiment, the requested string is an identifier of all strings of the client. In yet another embodiment, the requested string is an identifier of a subtree of strings. The requested string identifier is transmitted with the identified language of stage 1000. In the event that the language in stage 1000 is identified at server 110, the requested string is transmitted identifier is transmitted without a language identifier.

In stage 1020, server 110, retrieves the string associated with the transmitted identifier of stage 1010 and the identified language of stage 1000. In stage 1030, server 110 transmits the retrieved string, in the identified language, of stage 1020 to the client. In stage 1040, the client displays the screen in the identified language, responsive to the retrieved string of stage 1020.

In stage 1050, the client generates a request for a display in a different language, and transmits the request to server 100. The newly requested language is in one embodiment transmitted with the identified string of stage 1010. In stage 1060, server 110 retrieves the string associated with the transmitted identifier and newly requested language of stage 1060. In stage 1070, server 110 transmits the retrieved string, in the newly identified language of stage 1050 to the client. In stage 1080, the client dynamically displays the screen in the newly identified language, responsive to the retrieved string of stage 1070. Advantageously, and as described above in relation to IText, the newly identified language is immediately displayed without requiring reloading of a web page or restarting the current application.

Thus, the present embodiments enable a computer implemented method of internationalization by storing sets of strings, in a plurality of languages, on a server. A client, embodied in one or more of client software, a static web page or a dynamic web page, requests strings in a desired language from the server. Preferably, the desired language is provided by one of the selected preferred language of a web browser, a user selection and a language associated with the IP address of the client.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. A computer implemented method of displaying screen information, comprising:
storing strings in a plurality of languages;
identifying a user's language selection; and
transmitting said stored strings consonant with said received user's language selection; and
dynamically displaying screen information of an application responsive to said transmitted stored strings,
wherein said dynamic display does not require restarting said application.

2. A computer implemented method according to claim 1, wherein said identifying a user's language selection comprises:
identifying the IP address associated with the user; and
identifying a language associated with a geographical indication of said identified IP address.

3. A computer implemented method according to claim 1, wherein said identifying a user's language selection comprises one of receiving a user input, and retrieving the user's language selection from a web browser setting.

4. A computer implemented method according to claim 1, further comprising receiving an identifier of particular ones of said stored strings, and wherein said transmitted stored strings are said particular ones.

5. A computer implemented method according to claim 4, wherein said identifiers of particular ones is a subtree of strings.

6. A computer implemented method according to claim 4, wherein said identifiers of particular ones is one of: a particular string and all strings of said user associated with the application.

7. A computer implemented method according to claim 1, wherein said storing strings in a plurality of languages comprises:
providing a translator interface, wherein said translator interface provides strings in a collapsible tree.

8. A computer-readable medium containing instructions for controlling a client server architecture to perform a computer implemented method of displaying screen information, the method comprising:
storing strings in a plurality of languages;
identifying a user's language selection;
transmitting said stored strings consonant with said received user's language selection; and
dynamically displaying screen information of an application responsive to said transmitted stored strings,
wherein said dynamic display does not require restarting said application.

9. A computer-readable medium according to claim 8, wherein said identifying a user's language selection of the method comprises:
identifying the IP address associated with the user; and
identifying a language associated with a geographical indication of said identified IP address.

10. A computer-readable medium according to claim 8, wherein said identifying a user's language selection of the method comprises one of receiving a user input, and retrieving the user's language selection from a web browser setting.

11. A computer-readable medium according to claim 8, wherein the method further comprises receiving an identifier of particular ones of said stored strings, and wherein said transmitted stored strings are said particular ones.

12. A computer-readable medium according to claim 11, wherein said identifiers of particular ones is a subtree of strings.

13. A computer-readable medium according to claim 11, wherein said identifiers of particular ones is one of: a particular string and all strings of said user associated with the application.

14. A computer-readable medium according to claim 8, wherein said storing strings in a plurality of languages of the method comprises:
providing a translator interface, wherein said translator interface provides strings in a collapsible tree.

15. A client server architecture comprising a server and at least one client in communication with said server, the server being operative to:
store strings in a plurality of languages;
identify a user's language selection, said user associated with a particular client;
transmit said stored strings consonant with said received user's language selection; and
dynamically display screen information of an application responsive to said transmitted stored strings,
wherein said dynamic display does not require a restart of said application.

16. A client server architecture according to claim 15, wherein said identifying a user's language selection comprises:
identify the IP address associated with the particular client; and
identify a language associated with a geographical indication of said identified IP address.

17. A client server architecture according to claim 15, wherein said identifying a user's language selection comprises one of receiving a user input at the particular client, and retrieving the user's language selection from a web browser setting associated with the particular client.

18. A client server architecture according to claim 15, wherein said server is further operative to:
receive an identifier of particular ones of said stored strings, and
wherein said transmitted stored strings are said particular ones.

19. A client server architecture according to claim 18, wherein said identifiers of particular ones is a subtree of strings.

20. A client server architecture according to claim 18, wherein said identifiers of particular ones is one of: a particular string and all strings of said user associated with the application.

21. A client server architecture according to claim 15, wherein said server is further operative to provide a translator interface, wherein said translator interface provides strings in a collapsible tree.
